(19) United States
(12) Patent Application Publication
(10) Pub. No.: US 2009/0076985 A1
(43) Pub. Date: Mar. 19, 2009

(54) Method for Obtaining Biodiesel, Alternative Fuels and Renewable Fuels Tax Credits and Treatment

(75) Inventor: William Douglas Morgan, Richmond, CA (US)

Correspondence Address: KING & SPALDING, LLP, 1100 LOUISIANA ST., STE. 4000, ATTN.: IP Docketing, HOUSTON, TX, 77002-5213, US

(73) Assignee: ENDICOTT BIOFUELS II, LLC, Houston, TX (US)

(21) Appl. No.: 12/174,314

(22) Filed: Jul. 16, 2008

Related U.S. Application Data
(60) Provisional application No. 60/973,745, filed on Sep. 19, 2007.

(51) Int. Cl. G06Q 90/00

(52) U.S. Cl. 705/500

(57) ABSTRACT

The present invention relates to a method of obtaining U.S. Federal and State tax credits, renewable fuel treatment under the EPA's Renewable Fuel Standard Program, and other incentives by production and sale of esters manufactured by the esterification of carboxylic acids using slurry phase, heterogeneous catalyzed, reactive distillation.

This application claims priority under 35 U.S.C. 119(e) to U.S. provisional application 60/973,745, filed Sep. 19, 2007, the contents of which are incorporated by reference in their entirety.

### FIELD OF INVENTION

The present invention relates to a method of obtaining U.S. Federal and State tax credits, U.S. Federal renewable fuel treatment, and other incentives by production of esters manufactured by the esterification of carboxylic acids using slurry phase, heterogeneous catalyzed, reactive distillation, and sale thereof for U.S. consumption as a renewable fuel.

### BACKGROUND

Diesel fuel is a refined petroleum product which is burned in the engines powering most of the world's trains, ships, and large trucks. Petroleum is a non-renewable resource of finite supply. Acute shortages and dramatic price increases in petroleum and the refined products derived from petroleum have been suffered by industrialized countries during the past quarter-century. Furthermore, diesel engines which run on petroleum based diesel emit relatively high levels of certain pollutants, especially particulates. Accordingly, research effort is now being directed toward replacing some or all petroleum-based diesel fuel with a cleaner-burning fuel derived from renewable sources such as farm crops, agricultural waste streams or municipal or other waste streams.

In an effort to partially replace dependence on petroleum-based diesel, vegetable oils have been directly added to diesel fuel. These vegetable oils are composed mainly of triglycerides, and often contain small amounts (typically between 1 and 10% by weight) of free fatty acids. Some vegetable oils may also contain small amounts (typically less than a few percent by weight) of mono- and di-glycerides.

Triglycerides are esters of glycerol, CH₂(OH)CH(OH)CH₂(OH), and three fatty acids. Fatty acids are, in turn, aliphatic compounds containing 4 to 24 carbon atoms and having a terminal carboxyl group. Diglycerides are esters of glycerol and two fatty acids, and monoglycerides are esters of glycerol and one fatty acid. Naturally occurring fatty acids, with only minor exceptions, have an even number of carbon atoms and, if any unsaturation is present, the first double bond is generally located between the ninth and tenth carbon atoms. The characteristics of the triglyceride are influenced by the nature of their fatty acid residues.

The production of alkyl esters from glycerides by transesterification is a known process. However, transesterification suffers in that the reaction generally requires the addition of an acid or base catalyst which must be neutralized after the reaction thereby generating salts and soaps. In addition, while transesterification results in the separation of fatty acid esters from triglycerides, it also results in the production of glycerin, which must then be separated from the fatty acid esters, excess alcohol, salts, and soaps. Furthermore, the use of a strong acid, such as sulfuric acid, typically leads to higher sulfur content in the resulting biodiesel as the acid reacts with the double bonds in the fatty acid chains.

In an effort to overcome some of the problems associated with transesterification, several attempts have been made to employ esterification between fatty acids and alcohols. In these processes fatty acids are prepared from triglycerides by hydrolysis, followed by catalyzed esterification of the fatty acids with an alcohol, preferably methanol. While this procedure is practiced in the production of fatty alcohols and fatty acid esters, as described in U.S. Pat. No. 5,536,856 (Harrison et al.), it has not been practiced in the production of biodiesel fuel.

Despite any research that may now be directed toward replacing some or all petroleum-based diesel fuel with a cleaner-burning fuel derived from a renewable source such as farm crops, processes for producing renewable fuels as an alternative to petroleum products have not had economic success. As a result, both federal and state governments in the United States have created economic incentives for alternative fuels. However, for any original process in development, there may be no information as to the incentives and credits for which the process may be eligible. Thus, there is a need for methods of obtaining economic incentives and tax credits for original processes, particularly in relation to the alternative fuel industry.

### SUMMARY OF INVENTION

The present invention provides for the use of heterogeneous, slurry phase, reactive distillation to convert carboxylic acids to esters. In a preferred embodiment, the present invention employs reactive distillation as a method to assist in the production of biodiesel fuel having low glycerin, water and sulfur content. Reactive distillation is a method wherein specific reactions are driven forward despite an unfavorable equilibrium position for the main reaction, where the driving force during the reaction is the continuous removal of one or more substances from the reaction mixture. By removal of one or more products, the reaction equilibrium may become favorable. Sulfur content is reduced by employing reactive distillation over a solid catalyst bed and free glycerin concentration is reduced by employing fat hydrolysis.

While the present invention is a technical advance over the prior art, various marketplace factors may interfere with the widespread adoption of the present invention. Therefore, the present invention also provides methods for obtaining Federal and State Tax Credits and other incentives for the production of biodiesel and alternative ester-based fuels. In a preferred embodiment, the disclosed process for production of ester-based fuels is coupled with the methods of obtaining credits and incentives in order to provide cost advantages over the prior art.

According to one aspect of the present invention, carboxylic acids suitable for further conversion to fuel esters, the use of which can further generate tax credits and other incentives, are obtained by hydrolysis of glycerides, by distillation from mixtures of fatty acids and glycerides, or by acidulation of carboxylic acid soaps. The fatty acids are then transformed to biodiesel by reaction of a fatty acid component and an alcohol component, in which the fatty acid component and alcohol component are passed in countercurrent relation through an esterification zone maintained under esterification conditions and containing a solid esterification catalyst. In certain embodiments, the esterification catalyst may be selected from particulate ion exchange resins having sulfonic acid groups, carboxylic acid groups or both. The process is characterized in that the esterification zone includes a column reactor provided with a plurality of esterification trays mounted one above another, each adapted to hold a predetermined liquid volume and a charge of solid esterification catalyst. The less volatile component of the fatty acid component and of the alcohol component is supplied in liquid phase to the uppermost section of the reaction column and the more volatile component is supplied as a vapor to a lower portion of the reaction column. Vapor comprising the more volatile component and water from the esterification can be recovered from an upper part of the column reactor, and the biodiesel can be recovered from a lower part of the column reactor.

In another embodiment, a process for the preparation of biodiesel from a fatty acid feedstock is provided. A methanol vapor feedstream and a fatty acid feedstream are continuously introduced to a reaction vessel. The methanol and fatty acid are catalytically reacted in a reaction zone in the presence of a heterogeneous esterification catalyst within the reaction vessel to produce fatty acid methyl esters and water. The water is removed from the reaction zone with the methanol vapor and is separated from the alcohol, and the biodiesel is collected as the bottoms product.

In another embodiment, a process for preparing a biodiesel fuel from a triglyceride feedstock, wherein the biodiesel has a low glycerin and sulfur content is provided. The triglyceride feedstock is introduced into a fat splitter to produce a fatty acid-rich feedstream, which can be continuously fed to a reaction vessel. Similarly, an alcohol vapor feedstream is introduced to the reaction column. The fatty acid feedstream and alcohol feedstream catalytically react as they pass countercurrently among the equilibrium stages that hold a solid catalyst to produce biodiesel and water. Water is stripped from the reaction vessel along with alcohol vapor due to the action of the equilibrium stages, separated from the alcohol in an additional step and the alcohol is recycled to the reaction vessel. In one embodiment, the catalytic zone includes an ion exchange resin catalyst comprising —SO₃H or —CO₂H functional groups.

In another embodiment, a biodiesel fuel is prepared having water content less than 0.050% by volume. In another embodiment, the biodiesel fuel has a kinematic viscosity that is between 1.9 and 6 mm²/s. In another embodiment, the biodiesel fuel has a sulfur content that is less than 500 ppm, preferably less than 15 ppm. In another embodiment, the free glycerin content of the biodiesel fuel is less than 0.020% by weight. In another embodiment, the total glycerin content of the biodiesel is less than 0.240% by weight.

In another embodiment, biodiesel prepared by the methods of this invention are further employed to obtain tax credits, production incentives, renewable fuel treatment or all three. In one embodiment, esters that meet IRC's definition of Agri-Biodiesel are prepared from fatty acids according to the methods of the invention. These esters are then blended with 0.1 to 99.9% taxable diesel (as defined by IRC) prior to sale to a third party for use as or used by the producing taxpayer for fuel. In doing this, $1.00 per gallon in refundable tax credits under IRC Section 6426 are obtained from the Federal Government, if available. Depending on the state where the material is produced, state incentives are also obtained.

In another embodiment, esters meeting IRC's definition of biodiesel are produced, blended according to 6426 rules, and then sold to a third party for use as or used by the producing taxpayer for fuel and $0.50 per gallon in refundable Federal tax credits are obtained, if available. Depending on the state where material is produced, state incentives are also obtained.

In another embodiment, esters that fail to meet IRC's definition of Agri-biodiesel or biodiesel but which meet ASTM specifications for other fuels are blended with taxable fuel and sold for use as a fuel or used by the producing taxpayer in order to generate $0.50 in refundable Federal tax credits under Section 6426, if available, along with any additional state incentives.

In another embodiment, application is made to EPA for registration of esters that otherwise fail to meet IRC's definition of Agri-biodiesel or biodiesel but which meet ASTM specifications for other fuels. Once registration is obtained, these non-biodiesel esters are blended with taxable fuel and sold for use as a fuel or used by the producing taxpayer in order to generate $1.00 in non-refundable Federal tax credits under Section 40A, if available, along with any additional state incentives.

In another embodiment, the producers maintain qualification as a small agri-biodiesel producer such that the methods of the invention permit claiming of small agri-biodiesel producer credits from the federal government.

In another embodiment of the invention, esters meeting the definition of biodiesel and/or Agri-biodiesel are used by the taxpaying producer or placed directly in the fuel tank of a user at retail without blending with other taxable fuel. In doing so, non-refundable Federal Tax credits of $0.50 for biodiesel and/or $1.00 per gallon for Agri-biodiesel are generated under Section 40A, if available, along with any applicable state credits and/or incentives.

In another embodiment of the invention, by-products from the method of the invention such as distillation bottoms are blended with taxable fuel and sold to third parties for use as or used by the producing taxpayer as fuel. In doing so, $0.50 in refundable Federal Tax Credits are obtained under Section 6426, if available, along with any other applicable Federal and state credits or incentives.

In yet another embodiment of the invention, application is made to the EPA for registration of esters that meet the definition of Advanced Biofuel or Biomass-based Diesel as appropriate according to the Energy Independence and Security Act of 2007, Section 211. In doing so, these esters will meet the statutory definition of renewable fuel according to the EPA Regulation of Fuels and Fuel Additives: Renewable Fuel Standard Program and these esters will then be assigned a Renewable Identification Number (RIN).

### BRIEF DESCRIPTION OF THE DRAWINGS

FIG. 1 is a flow diagram of a plant for the production of methyl esters of fatty acids wherein the plant is constructed in accordance with the invention.

FIG. 2 is a flow diagram of a plant for the production of a carboxylic acid ester which has a significantly higher boiling point than the alcohol from which the alcohol moiety is derived, than water, or than any alcohol/water azeotrope formed.

FIG. 3 illustrates an esterification tray in one embodiment of the invention.

FIG. 4 illustrates an esterification tray in another embodiment of the invention.

FIG. 5 illustrates an esterification tray in yet another embodiment of the invention.

FIG. 6 is a flow diagram of the plant illustrated in FIG. 1 except that there is no feed line 2 for recycled methanol.

### DETAILED DESCRIPTION

The present invention relates to a method of obtaining U.S. Federal and State tax credits, renewable fuel treatment and other incentives via the production of ester fuels.

### Obtaining Tax Credits or Other Production Incentives

In the U.S., federal and state tax credits as well as producer incentive payments can be obtained for the production and sale of “Biodiesel” (also known as biodiesel) hereinafter defined as monoalkyl esters of long chain fatty acids derived from plant or animal matter which meet (A) the registration requirements for fuels and fuel additives established by the Environmental Protection Agency under section 211 of the Clean Air Act (42 U.S.C. 7545), and as amended by the Energy Independence and Security Act of 2007 and (B) the requirements of the American Society of Testing and Materials D6751.

Tax credits for the production of and sale of ester-based fuels are provided under three sections of Internal Revenue Code (IRC) (U.S. Code of Federal Regulations Title 26). Section 40A provides non-refundable credits for the use or sale of pure esters meeting the above specifications and registration requirements. IRC Section 40A provides refundable tax credits for “Biodiesel” of $0.50 per gallon for general biodiesel. Section 40A also provides refundable credits of $1.00 per gallon for Agri-biodiesel hereinafter defined as biodiesel derived solely from virgin oils, including esters derived from virgin vegetable oils from corn, soybeans, sunflower seeds, cottonseeds, canola, crambe, rapeseeds, safflowers, flaxseeds, rice bran, and mustard seeds, and from animal fats. IRC Section 40A also provides $0.10 per gallon of small producers credits for qualified small producers of Agri-biodiesel where qualified small producers are defined by the code.

IRC Section 6426 provides refundable credits of $0.50 per gallon for general biodiesel and $ 1.00 per gallon for Agri-biodiesel mixtures for sale or use in a trade or business of the taxpayer. The term “Biodiesel mixture” is further qualified as:
a mixture of Biodiesel and diesel fuel (as defined in section 4083(a)(3)), determined without regard to any use of kerosene, which
(A) is sold by the taxpayer producing such mixture to any person for use as a fuel, or
(B) is used as a fuel by the taxpayer producing such mixture.
   IRC Section 6426 also provides refundable tax credits of $0.50 per gallon for liquid hydrocarbons, other than ethanol, methanol, or biodiesel, derived from biomass that are used as a fuel in a motorboat or motor vehicle. Section 6426 also provides refundable credits of $0.50 per gallon for mixtures of alternative fuels with taxable fuel that are sold or used as fuel by the taxpayer.

Section 211 of the Clean Air Act (42 U.S.C. 7545), as amended by the Energy Independence and Security Act of 2007 provides for the treatment of advanced biofuels and biomass-based diesel (both considered “biodiesel” for purposes of this document) as a qualifying fuel under the EPA Renewable Fuel Standard Program, and the registration thereof resulting in the creation of renewable identification numbers (RINs) for every 1,000 gallons produced.

Several state legislatures have also weighed in with various tax credits and other incentives that relate back to the Biodiesel and Alternative Fuel definitions promulgated by IRC, as summarized in Table 1:

| | | FLEET | |
|---|---|---|---|
| | TAX CREDITS/REBATES/GRANTS | CREDITS | FEDERAL/STATE MANDATES |
| Alaska | | | Department of Transportation (DOT) is required to |
| | | | consider using alternative fuels for automotive purposes |
| | | | whenever practicable. DOT may participate in joint |
| | | | ventures with public or private partners that will foster |
| | | | the availability of alternative fuel for all consumers of |
| | | | automobile fuel. |
| Arizona | | Local governments | New motor vehicle dealers are required to make |
| | | in areas of | information on AFVs and incentives in Arizona for |
| | | Maricopa, Pinal, | purchasing or leasing AFVs available to the public |
| | | Yavapai, and Pima | Biodiesel for sale must meet the ASTM specifications |
| | | counties are | D6751. Blends of Biodiesel sold must meet the D975 |
| | | required to develop | specifications. |
| | | and implement a | |
| | | vehicle fleet plan | |
| | | for the purpose of | |
| | | encouraging and | |
| | | increasing the use | |
| | | of alternative fuels. | |
| Arkansas | Alternative Fuel Commission may | | |
| | provide grants of up to $0.10 per gallon | | |
| | for production of biodiesel up to 5 | | |
| | million gallons per producer, per year, | | |
| | not to exceed 5 years | | |
| | Income tax credit of up to 5% of the | | |
| | costs of facilities and equipment used in | | |
| | wholesale or retail distribution of | | |
| | biodiesel fuels | | |
| | $0.50 tax refund per gallon of biodiesel | | |
| | fuel used to produce a biodiesel mixture | | |
| | that contains not more than 2% and is for | | |
| | sale by the supplier for use by the | | |
| | supplier in trade or business | | |
| California | Lower-Emission School Bus Program | | SCAQMD can require government fleets and private |
| | Grants for school districts to obtain | | contractors under contract with public entities to |
| | buses which are lower-emitting | | purchase cleaner, alternative fuel vehicles. Rules are |
| | alternative fuel or diesel models and to | | applicable in Los Angeles; San Bernardino, Riverside |
| | retrofit in-use diesel buses with emission | | and Orange Counties. |
| | control devices CARB/CEC directed to | | Every city, county and special district, including school |
| | develop a plan allocating $25 million in | | districts and community colleges can require that 75% of |
| | incentives for among other things, | | the passenger cars and/or light duty trucks acquired be |
| | construction of retail fleet refueling | | energy-efficient vehicles. |
| | stations and for alternate fuel production | | The SJVAPCD is authorized to adopt regulations that |
| | in California. | | promote the use of alternative fuels and require the use |
| | The CMMAQSAP provides incentive | | of best pollution control technology for new and |
| | based funding for incremental cost of | | modified sources of pollution. They may establish |
| | purchasing cleaner than required engines | | expedited permit review and assistance for facilities |
| | and equipment. Eligible products | | projects that are directly related to the use of clean fuel |
| | include: on-road, off-road, marine, | | vehicle technologies. |
| | locomotive, agricultural engines, | | E85 fuel must meet the ASTM International |
| | forklifts, airport ground support | | specifications. |
| | equipment, auxiliary power units, heavy- | | Diesel fuel used for blending must meet the ASTM |
| | duty fleet modernization projects, | | International specifications. |
| | projects for cars & light-duty trucks. | | Blending stock must meet the ASTM International |
| | In San Joaquin Valley the REMOVE II | | specifications. |
| | program provides incentives for the | | Finished biodiesel blend must meet the ASTM |
| | purchase of low-emissions passenger | | International specifications. |
| | vehicles, light trucks, small buses and | | |
| | trucks under 14,000 pounds GVWR. | | |
| | The AB2766 program provides | | |
| | grants/loans to projects that reduce | | |
| | on/off road emissions. Funds may be | | |
| | used to purchase AFV vehicles and | | |
| | building alternative fuel and technology | | |
| | infrastructure | | |
| Colorado | Tax credit issued (years prior to 2011) | | By Jan. 01, 2007, The Executive Director of State |
| | for actual costs of construction, | | personnel must adopt a policy that requires all |
| | reconstruction, or acquisition of an | | state-owned diesel vehicles and equipment to be |
| | alternate fuel refueling facility | | fueled with B20 biodiesel blend. |
| | attributable to storage, compression, | | |
| | charging or dispensing of alternative | | |
| | fuels. | | |
| | CDR rebate available for the purchase of | | |
| | an AFV or conversion of an existing | | |
| | vehicle if owned by the State of | | |
| | Colorado, a political subdivision of the | | |
| | state or a tax-exempt organization and | | |
| | used in connection with the official | | |
| | activities of the entity | | |
| Connecticut | | AFVs purchased | |
| | | for state fleet to | |
| | | meet State Agency | |
| | | Emission | |
| | | Reduction policies | |
| | | must be able to use | |
| | | alternative fuel that | |
| | | is available within | |
| | | the state. | |
| Delaware | Green Energy Fund grants for the | | |
| | development, promotion and support of | | |
| | energy efficiency programs including | | |
| | biodiesel manufacturing facilities. | | |
| | Waiving of taxes on alternative fuels | | |
| | used in official vehicles for the U.S. or | | |
| | any governmental agency, including | | |
| | state agencies and volunteer fire and | | |
| | rescue companies. | | |
| | The DSB offers rebates and marketing, | | |
| | promotion, and education assistance for | | |
| | biodiesel use on a case-by-case basis. | | |
| District of | | Fleet operators | |
| Columbia | | who control at | |
| | | least 10 clean fuel | |
| | | vehicles in an | |
| | | ozone non- | |
| | | attainment area, | |
| | | are exempt from | |
| | | time-of-day, day- | |
| | | of-week | |
| | | restrictions and | |
| | | commercial | |
| | | vehicle bans. | |
| Florida | Exemption from state sales, rental, use, | State and Local | |
| | consumption, distribution and storage | Government AFV | |
| | tax on materials used in the distribution | fleet vehicles are | |
| | of biodiesel and ethanol, including | exempt from | |
| | refueling infrastructure, transportation, | purchasing the | |
| | and storage up to a maximum of $1 | state decal required | |
| | million in taxes each year for all | in lieu of excise | |
| | taxpayers. | tax on gasoline. | |
| | A state sales tax credit for costs incurred | | |
| | between Jul. 1, 2006 and Jun. 30, 2010 | | |
| | for 75% of all capital costs, operation | | |
| | and distribution of biodiesel and ethanol | | |
| | in the state | | |
| Georgia | | | Biodiesel produced or sold, including use for blending, |
| | | | must meet the ASTM standard D 6751. |
| Hawaii | Taxpayers making a high technology | State agencies | Contracts for the purchase of diesel fuel are to be |
| | business investment for which 75% o of | must purchase | awarded with preference given to bids for biofuels or |
| | the income (in state only) is related to | alternative fuels | blends of biofuel and petroleum fuel. The alternative |
| | research pertaining to non-fossil fuel | and ethanol | fuel standard will be 10% of all highway fuel use to be |
| | energy technology are eligible for a tax | blended gasoline | provided by alternative fuels by 2010, 15% by 2015 and |
| | credit equal to a percentage of the | when available: | 20% by 2020. |
| | investment made. | evaluate a | |
| | | purchase | |
| | | preference for | |
| | | biodiesel blends: | |
| | | and promote | |
| | | efficient operations | |
| | | of vehicles. | |
| Idaho | Tax deduction to licensed motor fuel | | |
| | distributors for the number of gallons of | | |
| | agricultural products or animal fats or | | |
| | the wastes of such products contained in | | |
| | biodiesel fuel. | | |
| Illinois | Illinois Clean School Bus program | The Illinois Green | Any diesel powered vehicle owned or operated by the |
| | provides funding to assist schools/school | Fleet Program | state, county or local government, school district, |
| | districts to reduce emissions from diesel | provides additional | community or public college or university, or mass |
| | powered school buses through emission | marketing | transit are required to use a biodiesel blend of at least 2% |
| | control retrofits, and implementation of | opportunities for | when refueling at a bulk central fueling station. |
| | cleaner fuels including biodiesel. | Fleets that have a | State agencies may give preference to an otherwise |
| | Rebate for 80% of the incremental cost | significant number | qualified bidder who will fulfill a contract through the |
| | of purchasing an AFV, SO % of the | of AFVs and use | use of vehicles powered by ethanol produced from |
| | incremental cost of fuel vehicle | American | Illinois coin or biodiesel fuel produced from Illinois |
| | conversion, and for the incremental cost | produced-fuels. | soybeans. |
| | of purchasing alternative fuels. The | Additionally, | |
| | rebate program is open to all Illinois | commercial or | |
| | residents, businesses, government units | retail fuel stations | |
| | except federal) and organizations located | that sell E85, | |
| | in Illinois | natural gas, | |
| | | propane, or other | |
| | | clean fuels as well | |
| | | as dealerships that | |
| | | promote the sale of | |
| | | AFVs and educate | |
| | | their customers | |
| | | about AFVs | |
| | | receive special | |
| | | recognition. | |
| Indiana | Taxpayers that produce blended | The OED and the | Government entities are required to fuel diesel vehicles |
| | biodiesel at a facility located in Indiana | ISDA provides | with biodiesel whenever possible. |
| | are eligible for a tax credit of $1 per | grants the help fuel | |
| | gallon of biodiesel that is used to | retailers increase | |
| | | the use of biofuels | |
| | produce blended biodiesel. | across the state, | |
| | Taxpayers that produce blended | Large fleet | |
| | biodiesel at a facility in Indiana are | operators are | |
| | entitled to a credit of $0.02 per gallon of | Eligible to apply | |
| | blended biodiesel. | for funding on | |
| | A taxpayer that is a fuel retailer and | projects that | |
| | distributes blended biodiesel for retail | include the | |
| | purposes is entitled to a credit of $0.01 | installation of E85 | |
| | per gallon of blended biodiesel | or B20 refueling | |
| | distributed for retail purposes. | infrastructure, | |
| | Government bodies, state educational | Matching funds of | |
| | institutions or instrumentality of the state | 50% are required. | |
| | that performs essential governmental | | |
| | functions on a statewide or local basis is | | |
| | entitled to a price preference of 10% for | | |
| | the purchase of fuels which are at least | | |
| | 20% biodiesel by volume, An area may | | |
| | be designated as a Certified Technology | | |
| | Park (allowing for certain tax incentives) | | |
| | if it meets certain criteria including a | | |
| | commitment from at least one business | | |
| | engaged in a high technology activity | | |
| | which involves electric vehicles, hybrid | | |
| | electric vehicles, or alternative fuel | | |
| | vehicles or components used in the | | |
| | construction of these vehicles. | | |
| Iowa | Through Dec. 31, 2011, retailers | | All state agencies must ensure that all bulk diesel fuel |
| | whose diesel sales are at least 50% | | procured contains at least 5% renewable content by |
| | biodiesel are eligible for a $0.03 per | | 2007, 10% by 2008, and 20% by 2010 provided that fuel |
| | gallon tax credit oil each gallon of B2 or | | meets ASTM D 6751 standards and is available. |
| | higher sold Biodiesel blenders may | | At least 10% of new light-duty vehicles purchased by |
| | apply for a cost-share grant for terminal | | institutions under the control of the state fleet |
| | distribution facilities' grants could cover | | administrator, IDOT administrator, BOD of community |
| | 50% of the costs of the project up to a | | colleges, state board of regents, commission for the |
| | max of $50,000K. 0% interest loans are | | blind, and Department of Corrections must be capable of |
| | available for tip to half the cost of | | using alternative feels. |
| | biomass or alternative fuel production | | |
| | related projects through Iowa's | | |
| | Alternative Energy Revolving Loan | | |
| | Program. | | |
| | AFV grants are awarded for research | | |
| | connected with the fuel or an AFV | | |
| | vehicle, but not for the purchase of the | | |
| | vehicle itself. | | |
| Kansas | A $0.30 per gallon incentive is | | A 2% or higher blend of biodiesel must be purchased for |
| | applicable to biodiesel fuel sold by a | | use in state-owned diesel vehicles and equipment, where |
| | qualified Kansas biodiesel fuel producer | | available, and as long as the incremental price does not |
| | Income tax credit for refueling stations | | exceed $.10 per gallon as compared to diesel fuel. |
| | placed in service after Jan. 1, 2005. | | Individuals operating state-owned vehicles must |
| | The tax credit may not exceed $160.000. | | purchase fuel blends containing at least 10% ethanol. |
| | | | For model year 2000 and thereafter, 75% of new light- |
| | | | duty vehicles acquired by the state fleet and its agencies, |
| | | | which are used in the metropolitan statistical area, are |
| | | | required to be ATVs. |
| Kentucky | An income tax credit is available for | | Kentucky Transportation Cabinet and the Finance and |
| | biodiesel producers and blenders at a | | Administration Cabinet employees using conventional |
| | rate of $1.00 per gallon. | | vehicles in the fleet are directed to use either E10 or B2 |
| | | | as their primary fuel option. |
| | | | The Transportation Cabinet is directed to maximize the |
| | | | use of E85 in its fleet flexible fuel vehicles. |
| Louisiana | Certain property acid equipment used in | | Renewable fuel plants operating in Louisiana and |
| | the manufacture production or extraction | | deriving ethanol from the distillation of corn must use at |
| | of unblended biodiesel, as well as | | least 20% corn crop harvested in Louisiana as feedstock. |
| | unblended biodiesel used as fuel bay a | | Renewable fuel plants operating in Louisiana and |
| | registered manufacturer, are exempt | | deriving biodiesel from soybeans and other crops must |
| | from state sales and use tax. | | use at least 2.5% of the soybean crop harvested in |
| | | | Louisiana as feedstock. |
| Maine | There is a state income tax credit of $.05 | | State agencies shall promote the procurement of |
| | per gallon for the commercial production | | dedicated alternative fuel vehicles dual fuel vehicles and |
| | of biofuels for use in motor vehicles or | | supporting refueling infrastructures. |
| | otherwise used as a substitute for liquid | | |
| | fuels. | | |
| | A tax credit is available for the | | |
| | construction or installation of, or | | |
| | improvements to any refueling or | | |
| | charging station for purposes of | | |
| | providing clean fuels to the general | | |
| | public for use in motor vehicles. The | | |
| | qualifying percentage is 25% for | | |
| | expenditures made from | | |
| | Jan. 01, 2002-Dec. 31, 2008. | | |
| | The Clean Fuel Vehicle fund provides | | |
| | non-lapsing revolving loans that may be | | |
| | used to finance all or part of any clean | | |
| | fuel vehicle project. | | |
| Maryland | Biodiesel producers may apply to the | | The state shall ensure that an average of 50% of fuel |
| | Renewable Fuels Incentive Board for | | used by bi-fuel and flex-fuel vehicles shall be alternative |
| | production credits. | | fuel. |
| | | | The state shall help develop the refueling and |
| | | | maintenance infrastructure required to make using |
| | | | certain types of AFVs practical. |
| | | | At least 50% of the state vehicles must use a minimum |
| | | | biodiesel blend of B5 by the beginning of the 2008 fiscal |
| | | | year. |
| Massachusetts | | | State fleets must acquire AFVs according to the |
| | | | requirements of the EPAct of 1992. |
| Michigan | Tax exemption may apply to an | | |
| | industrial property which is used for, | | |
| | among other purposes, high-technology | | |
| | activities or the creation or synthesis of | | |
| | biodiesel fuel. | | |
| | A matching grant program available to | | |
| | service stations to convert existing, and | | |
| | install new, fuel delivery systems to | | |
| | provide E85 and biodiesel blends. | | |
| Minnesota | | | State agencies are required to take all reasonable actions |
| | | | necessary to strengthen the infrastructure for increasing |
| | | | the availability and use of E85 and biodiesel throughout |
| | | | the state. |
| | | | Employees using state vehicles are expected to use E85 |
| | | | whenever it is available. |
| | | | The state is required to achieve a 25% and 50% |
| | | | reduction in the use of gasoline for state department |
| | | | owned vehicles by 2010 and 2015 respectively. All |
| | | | diesel fuel sold or offered for sale in the state for use in |
| | | | internal combustion engines roust contain at least 2% |
| | | | biofuel by volume. State agencies are required to use |
| | | | alternative fuels in state motor vehicles if the clean fuels |
| | | | are reasonable available at similar cost to other fuels and |
| | | | are compatible with the intended use of the vehicle. |
| Mississippi | Incentive of $0.20 per biodiesel gallons | | |
| | produced annually up to 30 million | | |
| | gallons per year, per producer for tip to | | |
| | 10 years | | |
| Missouri | Grants available to qualified biodiesel | The Biodiesel Fuel | At least 75% of the MoDOT vehicle fleet and heavy |
| | producers, $0.30 per gallon for the first | Revolving Fund | equipment that use diesel fuel must be fueled with B20 |
| | 15 million gallons produced in a fiscal | uses money | or higher biodiesel blends, if such fuel is commercially |
| | year, $0.10 per gallon for the next 15 | generated by the | made. |
| | million gallons in a fiscal year, up to 30 | sale of EPAct | Any state agency operating a fleet of more than 15 |
| | million gallons per year for 60 months. | credits to cover the | vehicles must ensure that 50% of new vehicles acquired |
| | Restrictions apply, School districts who | incremental cost of | are capable of running on alternative fuels 30% of the |
| | establish a contract with an eligible new | purchasing fuel | fuel purchased annually for use in state vehicles must be |
| | generation coop for biodiesel will | containing B20 or | alternative fuel. |
| | receive an additional payment to offset | higher fuel blends | |
| | the incremental cost of the fuel | for state fleet | |
| | | vehicles. | |
| Montana | A tax credit available to businesses and | | |
| | individuals for up to 15% of the cost of | | |
| | storage and blending equipment used for | | |
| | blending biodiesel with petroleum diesel. | | |
| | Licensed distributors paying special tax | | |
| | fuel on biodiesel may claim a refund of | | |
| | $0.02 per gallon sold during the previous | | |
| | year if all ingredients of the biodiesel | | |
| | were produced in state. | | |
| | Owner/operators of retail motor Kiel | | |
| | outlet may claim a refund of $0.01 per | | |
| | gallon of biodiesel purchased from a | | |
| | licenses distributor if the biodiesel | | |
| | ingredients were all produced in state. | | |
| | A tax credit for up to 15% of the cost to | | |
| | construct and equip a biodiesel | | |
| | production facility Income tax credit for | | |
| | up to 50% of the labor & equipment cost | | |
| | to convert vehicles to use alternative | | |
| | fuels. (business Individual) | | |
| Nebraska | Motors fuels sold to a biodiesel | | State employees operating state fleet flexible-fuel or |
| | production facility and that | | diesel vehicles are required to use E85 or biodiesel |
| | manufactured at same are exempt from | | blends whenever reasonable available. |
| | certain motor fuel taxes laws. | | |
| | The NEO offers low-cost loans for a | | |
| | variety of alternative fuel projects. | | |
| Nevada | | | State (agencies, political subdivisions) fleets containing |
| | | | 10 or more vehicles in a county whose population is |
| | | | 100.000 or more are required to acquire AFVs or EPA |
| | | | certified low emission vehicles. |
| | | | Beginning in 2000 and each year thereafter, 90% of new |
| | | | vehicles obtained by covered fleets must be either AFVs |
| | | | or certified ULEVS. |
| New | | | State agencies are required to implement a Clean Fleets |
| Hampshire | | | Program. |
| New Jersey | Rebate offered to government entities for | | All buses purchased by the New Jersey Transit Corp. |
| | the incremental costs of purchasing | | must be equipped with improved pollution controls and |
| | AFVs or converting vehicles to use | | be powered by a fuel other than conventional diesel |
| | alternative fuels | | |
| | Rebate to local governments, state | | |
| | colleges/universities, school districts and | | |
| | governmental authorities for the | | |
| | incremental cost of using biodiesel fuel. | | |
| New Mexico | The value of biomass materials used for | $5 million | By 2010 all cabinet level state agencies, public schools |
| | processing into biofuels may be | revolving (low | and institutions of higher education are required to take |
| | deducted in computing the compensating | interest) loans | action toward obtaining at least 15% of their total |
| | tax due. | available for AFV | transportation fuel requirements from renewable fuels. |
| | Grants available to eligible participants | acquisitions by | 75% of state government and educational Institutions |
| | to support alternative fuel activities such | state agencies, | fleet vehicles acquired after 2003 be bi-fuel or dedicated |
| | as infrastructure development. | political | AFVs or gas-electric hybrid vehicles. |
| | Alternative fuel purchased for | subdivisions and | |
| | distribution shall not be subject to the | educational | |
| | excise tax at the time of purchase or | institutions. | |
| | acquisition. | | |
| | Alternative fuel purchased for | | |
| | distribution shall not be subject to the | | |
| | alternative fuel excise tax at the time of | | |
| | purchase or acquisition, but the tax shall | | |
| | be due on alternative fuel at the time it is | | |
| | dispensed or delivered into the tank of a | | |
| | motor vehicle that is operated on the | | |
| | highways of the state. | | |
| New York | A tax credit equal to up to 50% of the | Funds are provided | At least 80% of New York's light-duty, non-emergency |
| | cost of infrastructure including | to state and local | fleet, and 20% of bus Elects operated iii New York City |
| | infrastructure for storing or dispensing | transit agencies, | are required to be AFVS. |
| | clean burning fuel into the tank of a | municipalities, and | By 2010, 100% of all new light-duty (some exceptions) |
| | motor vehicle, | schools for up to | vehicles must be AFVs. |
| | | 100% of the | To the extent that gasoline powered state vehicles use |
| | | incremental cost of | central refueling stations, all state agencies and public |
| | | purchasing new | authorities must use E85 in flexible fuel vehicles |
| | | alternative fuel | whenever it is feasible to do so. |
| | | buses. Funds | |
| | | awarded to | |
| | | NYCCC that | |
| | | acquire AFVs and | |
| | | or refueling | |
| | | infrastructure. | |
| | | Components | |
| | | included are, | |
| | | incremental cost of | |
| | | purchasing AFVs, | |
| | | the cost of | |
| | | installing refueling | |
| | | and recharging | |
| | | equipment, and the | |
| | | incremental costs | |
| | | with bulk | |
| | | alternative fuel | |
| | | purchases | |
| North Carolina | A tax credit equal to the per gallon | | |
| | excise tax paid is an available to a | | |
| | biodiesel provider that produces at least | | |
| | 100,000 gallons during the taxable year. | | |
| | A taxpayer that constructs 3 or more | | |
| | renewable fuel processing facilities in | | |
| | state and invest at least $400,000,000 are | | |
| | eligible for a credit equal to 35% of the | | |
| | cost of constructing and equipping said | | |
| | facility. Taxpayers who construct, | | |
| | purchase or lease renewable energy | | |
| | property is eligible for a tax credit equal | | |
| | to 35% of the cost of the property. | | |
| | A tax credit equal to 15% of the cost of | | |
| | constructing and installing portion of a | | |
| | dispensing facility, including pumps, | | |
| | storage tanks and related equipment that | | |
| | is directly used for dispensing or storing | | |
| | biodiesel fuel Chants for the incremental | | |
| | cost of purchasing OEM AFVs vehicle | | |
| | retrofits implementing idle reduction | | |
| | programs, and constructing or installing | | |
| | alternative fuel public refueling | | |
| | facilities. | | |
| | The NCSPA offers new dealers and | | |
| | distributors of soy biodiesel a rebate on | | |
| | the first 250 of 500 gallons purchased | | |
| | and a 50% rebate to cover die cost of | | |
| | equipment changes needed to begin | | |
| | selling soy biodiesel | | |
| North Dakota | 5-year corporate income tax credit (up to | | |
| | 10% per year) for equipment that | | |
| | enables a facility to sell diesel fuel which | | |
| | contains 2% biodiesel by volume. | | |
| | Licensed fuel supplier who blends | | |
| | biodiesel into fuel comprised of at least | | |
| | 5% biodiesel is entitled to a tax credit of | | |
| | $0.05 per gallon of biodiesel fuel. | | |
| | Funds are available to participate in an | | |
| | Interest rate buy down on a loan to a | | |
| | biodiesel production facility for the | | |
| | following uses: purchase of real property | | |
| | and equipment; expansion of facilities; | | |
| | working capital and inventory. | | |
| | Reduction of $0.0105 per gallon | | |
| | reduction of state excise tax for the sales | | |
| | or delivery of diesel fuel containing at | | |
| | least 2% biodiesel fuel by weight. | | |
| Ohio | Funding, not to exceed 50% of total | | The ODOT fleet is required to use at least one million |
| | costs, is provided to retail fuel stations to | | gallons of biodiesel and 30,000 gallons of ethanol in fleet |
| | assist with installation and promotion of | | vehicles each year. |
| | E85 and or B20. | | All new ODOT vehicle purchases must be flexible fuel |
| | | | vehicles capable of operating on E85. |
| Oklahoma | A biodiesel (B1OQj production facility | A private loan | Law requires that all school and government vehicles |
| | is allowed a tax credit of $0.20 per | program with a 3% | capable of operating on alternative fuel to use the fuel |
| | gallon of biodiesel produced. | interest rate is | whenever a refueling station is in operation within a five- |
| | (Restrictions apply) | available for the | mile radius of the respective department or district. |
| | The Alternative Fuel Loan program has | cost of converting | |
| | funds available to help convert | private fleets to | |
| | government-owned fleets to operate on | operate on | |
| | alternative fuels. | alternative fuels, | |
| | | for incremental | |
| | | costs of purchasing | |
| | | OEM AFVs and | |
| | | for the installation | |
| | | of AFV fueling | |
| | | infrastructure. | |
| Oregon | Tax credit for business owners to offset | | State agencies and transit districts must purchase AFVs |
| | the incremental cost of purchasing | | to the extent possible. |
| | AFVs, the cost of converting vehicles to | | |
| | use alternative fuel, and the cost of | | |
| | constructing alternative fuel refueling | | |
| | stations. Credit equals 35% of | | |
| | incremental costs. | | |
| | Loan program available for alternative | | |
| | fuel projects including feel production | | |
| | facilities, dedicated feedstock | | |
| | production, fueling stations and fleet | | |
| | vehicles. | | |
| Pennsylvania | Tile Alternative Fuel Incentive Grant | | |
| | Fund provides funding to various | | |
| | governments, educational and non-profit | | |
| | organizations for projects with an | | |
| | emphasis on biofuels. | | |
| Rhode Island | Tax credit to taxpayers equal to 50% of | | |
| | the capital labor, and equipment costs for | | |
| | the construction of, or improvements to, | | |
| | any alternative fuel refueling or | | |
| | recharging station proving domestically | | |
| | produced alternative fuel. | | |
| | Corporations selling alternative fuels are | | |
| | allowed gross earnings from sales | | |
| | reduction equal to the total gross | | |
| | earnings from the sale of alternative | | |
| | fuels. | | |
| | The RISEO offers low fee loans to state | | |
| | agencies and municipal governments to | | |
| | cover incremental costs of purchasing | | |
| | original equipment manufactured AFVs. | | |
| | Organically produced biofuels are | | |
| | exempt from motor fuel tax. | | |
| South Carolina | A $0.05 payment is available to | | State agencies operating Alternative Fuel Vehicles are |
| | biodiesel retailers for each gallon of B20 | | required to use alternative fuel in those vehicles |
| | sold, provided the B20 fuel is subject to | | whenever practical and economically feasible. |
| | the S.C. motor fuel tax and the price of | | |
| | the lowest price of the B20 fuel is at | | |
| | least $0.05 lower than the priced non- | | |
| | B20 fuel being sold at the same facility. | | |
| | Business tax credits of $0.20 for each | | |
| | gallon of biodiesel motor fuel produced | | |
| | mostly from soybean and sold as well as | | |
| | a credit of $0.30 for each gallon of | | |
| | biodiesel motor fuel a majority of which | | |
| | is produced from feedstock other than | | |
| | soybean Tax credit for biodiesel | | |
| | facilities that were placed in use after | | |
| | 2006 and in production at the rate of at | | |
| | least 25% of the nameplate design | | |
| | capacity by Dec. 31, 2009. Credit equals | | |
| | $0.20 per gallon of biodiesel produced | | |
| | and is allowed beginning die first month | | |
| | the facility is eligible. A tax credit for | | |
| | 25% of the cost for constructing or | | |
| | installing equipment for the installation | | |
| | of a qualified commercial facility that | | |
| | distributes or dispenses ethanol or | | |
| | biodiesel. | | |
| South Dakota | Tax refund for contractors” excise and | | The SDDoT and state employees using state diesel |
| | sales and use taxes paid for construction | | vehicles are required to use a minimum 2% biodiesel |
| | of new or expansion of existing | | blended fuel which meets or exceeds the STM |
| | agricultural processing plant used for the | | specifications. |
| | production of biodiesel. | | |
| Tennessee | TDOT grants available to help fund | | |
| | capital costs to purchase, prepare, and | | |
| | install biofuel storage tanks and fuel | | |
| | pumps at private sector fuel stations | | |
| | Grants for county governments to install | | |
| | biodiesel infrastructure which will | | |
| | provide biodiesel fuel to county city | | |
| | owned vehicles. Funds granted for up to | | |
| | 50% of total project cost. | | |
| Texas | A non-profit grant program offers aid to | Grants for up to | |
| | local school districts in replacing aging | 75% of the | |
| | diesel fuel buses with new clean fuel | incremental cost to | |
| | buses. | purchase new | |
| | | OEM clean fuel | |
| | | vehicles and or | |
| | | conversions/ | |
| | | repowers. | |
| | | Limited to the | |
| | | 8 county Houston- | |
| | | Galveston non- | |
| | | attainment area. | |
| Utah | Income tax for 50% of incremental | | The UAQB is authorized to mandate fleet vehicles to use |
| | purchase cost of an OEM clean fuel | | clean fuels, if such a mandate is necessary in order to |
| | vehicle and or the conversion of a | | meet national air quality standards |
| | vehicle to operate of alternative fuel. | | |
| Vermont | Businesses that exclusively design | | The commissioner of building and general services must |
| | develop and manufacture EVs. AFVs or | | consider ATVs when purchasing fleet vehicles for the |
| | hybrid vehicles are eligible for income | | state. |
| | tax credits. | | |
| Virginia | The Biofuels Production Fund provides | | State agencies are requested to use biofuels where |
| | grants to producers of biofuels, | | feasible in fleet vehicles owned by the state or operated |
| | specifically ethanol and biodiesel. | | by the agency. |
| Washington | A tax deduction is available for the sale | | State agencies are encouraged to use a fuel blend of 20% |
| | or distribution of biodiesel or alcohol | | biodiesel and 80% petroleum diesel (B20) for use in |
| | fuel. | | diesel-powered vehicles. 85% of money received by an |
| | Fuel delivery vehicles and machinery, | | air pollution control authority or the State Department of |
| | equipment and related services are | | Licensing must be used for the Clean Bus Program to |
| | exempt from state retail fuel sales and | | retrofit buses to use cleaner burning fuels. At least 30% |
| | use taxes. | | of all new vehicles purchased through state contract must |
| | Until 2009, investment in buildings, | | be clean-fuel vehicles. |
| | equipment and labor for the purpose of | | |
| | manufacturing biodiesel, biodiesel | | |
| | feedstock, or alcohol fuel are eligible for | | |
| | deferral of state and local sales and use | | |
| | taxes. | | |
| | Qualifying buildings, equipment, and | | |
| | land uses in the manufacturing of | | |
| | alcohol fuels, biodiesel, or biodiesel | | |
| | feedstock are exempt from state and | | |
| | local property and leasehold taxes for a | | |
| | period of six years, reduced Business & | | |
| | Occupation tax rate applies to persons | | |
| | engaged in the manufacturing of alcohol | | |
| | fuel, biodiesel fuel or biodiesel | | |
| | feed stock. | | |
| West Virginia | | | The Secretary of Administration has the authority to |
| | | | require state, county municipal government fleets to |
| | | | make 75% of fleet purchases AFVs. |
| Wisconsin | The DPI may provide aid to school | | |
| | districts that use biodiesel fuel for | | |
| | .school bus transportation to cover the | | |
| | incremental cost of using biodiesel as | | |
| | compared to the cost of petroleum | | |
| | diesel. | | |

Depending on the final composition of the product produced according to the methods of the invention, various Federal and State tax credits and other production incentives are available. The procedure for obtaining tax credits under U.S. Code Title 26 section 6426 and 40A, for example, depends on which components meet Biodiesel, Agri-biodiesel, or Alternative Fuel definitions and specifications. The procedure for obtaining renewable fuel treatment and generating RINs under the EPA Clean Air Act as amended by the Energy Independence and Security Act of 2007 depends on whether the esters meet Biodiesel, Advanced Biofuels or Biomass-based fuels definitions and specifications.

When different components meet different specifications, for example Agri-Biodiesel and Alternative Fuel, it is necessary to establish the portion of the fuel that is attributable to each classification. Only in the case of determining the difference between Agri-Biodiesel and Biodiesel does feedstock composition come into consideration since Agri-Biodiesel must be derived solely from virgin oils.

In order to claim Federal tax credits, the claimant must first apply and be approved for “Certain Excise Tax Activities” registration. Once this is accomplished, and depending on whether the claimant will be claiming the tax credit directly or not, certain record-keeping requirements must be met and claims for tax credits filed.

As noted above, the product of the method of the invention can be blended with taxable fuel prior to sale or use under Section 6426. When this is done, the tax credits, if available, are refundable. Alternatively, the product can be used by the tax payer without blending or placed directly in the tank of an end user at retail in order to generate non-refundable credits under Section 40A.

If the producer qualifies under Section 40A as a small Agri-Biodiesel producer, then Section 40A small Agri-Biodiesel producer credits, if available, can be claimed.

If the producer qualifies under the Energy Independence and Security Act of 2007 as a biomass-based fuel producer, then the esters can be registered and RINs can be claimed.

### Production of Ester Fuels

The process of the invention utilizes the vaporous stream of the more volatile of the two components, i.e. the more volatile out of the carboxylic acid component and the alcohol component, to carry away water of esterification produced in the esterification reactor but without carrying with it significant quantities of the other, i.e. the less volatile one, of the two components or of the carboxylic acid ester. For this reason it is essential that the boiling point of the vaporous mixture exiting the esterification reactor, or of the highest boiling compound present in that vaporous mixture, shall be significantly lower, at the pressure prevailing in the uppermost stage of the esterification reactor, than the boiling point at that pressure either of the less volatile one of the two components, i.e. the less volatile out of the carboxylic acid component and the alcohol component, or of the carboxylic acid ester product. By the term “significantly lower” we mean that the boiling point difference shall be at least about 20° C., and preferably at least about 25° C., at the relevant operating pressure.

As examples of monoesterification reactions that can be conducted according to the present invention there can be mentioned the production of alkyl esters of aliphatic monocarboxylic acids from alkanols and aliphatic monocarboxylic acids or anhydrides thereof. Such monocarboxylic acids may contain, for example, from about 6 to about 26 carbon atoms and may include mixtures of two or more thereof. Alkyl esters derived from alkanols containing 1 to about 10 carbon atoms are of especial importance.

Such monocarboxylic acids include fatty acids such as decanoic acid, dodecanoic acid, tetradecanoic acid, hexadecanoic,acid, octadecanoic acid, octadecenoic acid, linoleic acid, eicosanoic acid, isostearic acid and the like, as well as mixtures of two or more thereof. Mixtures of fatty acids are produced commercially by hydrolysis of naturally occurring triglycerides of vegetable origin, such as coconut oil, rape seed oil, and palm oils, and triglycerides of animal origin, such as lard, tallow and fish oils. If desired, such mixtures of acids can be subjected to distillation to remove lower boiling acids having a lower boiling point than a chosen temperature (e.g. C₈ to C₁₀ acids) and thus produce a “topped” mixture of acids, or to remove higher boiling acids having a boiling point higher than a second chosen temperature (e.g. C₂₂₊acids) and thus produce a “tailed” mixture of acids, or to remove both lower and higher boiling acids and thus produce a “topped and tailed” mixture of acids. Such fatty acid mixtures may also contain ethylenically unsaturated acids such as oleic acid. These fatty acid mixtures can be esterified with methanol to yield methyl fatty acid ester mixtures that can be hydrogenated to yield mixtures of alkanols, e.g. C₈ to C₂₀ alkanols (often called detergent alcohols), that are acceptable for production of detergents without prior separation of the alkanols one from another. Such hydrogenation can be conducted either in the liquid phase or in the vapor phase (in which case hydrogenation conditions are advantageously selected such that the vaporous mixture in contact with the catalyst is always above its dew point, preferably at least about 5° C. above its dew point). As examples of suitable hydrogenation catalysts there can be mentioned copper chromite and reduced copper oxide-zinc oxide hydrogenation catalysts of the type disclosed in GB-B-2116552.

Another class of carboxylic acid esters that can be produced by the process of the invention are dialkyl esters of aliphatic and cycloaliphatic C₄ to C₁₈ saturated and unsaturated dicarboxylic acids. These can be produced by reaction of alkanols with the dicarboxylic acids or anhydrides thereof, or with mixtures of the dicarboxylic acid and its anhydride. Dialkyl oxalates, dialkyl maleates, dialkyl succinates, dialkyl fumarates, dialkyl glutarates, dialkyl pimelates, and dialkyl azelaates are examples of such dicarboxylic acid esters. Other examples of such esters include dialkyl esters of tetrahydrophthalic acid. The C₁ to C₁₀ alkyl esters of such dicarboxylic acids are of particular interest. Either the free dicarboxylic acid or its anhydride (if such exists) or a mixture of dicarboxylic acids and anhydride can be used as the carboxylic acid component starting material for production of such dialkyl esters. Alkyl esters of aromatic C₇ to C₂₀ monocarboxylic acids and mixtures thereof can be made by a process of the invention. Benzoic acid and 1-naphthoic acid are examples of such acids.

Alkyl esters of aromatic C₈ to C₂₀ dicarboxylic acids can also be produced by the process of the invention from the acids, their anhydrides and mixtures thereof.

It is also possible to produce polyalkyl esters of polycarboxylic acids by the process of the invention. Such polycarboxylic acid moieties include, for example, citric acid, pyromellitic dianhydride, and the like.

Carboxylic acid esters of dihydric and polyhydric alcohols can be produced by the process of the invention. Examples of such esters include ethylene glycol diformate, ethylene glycol diacetate, propylene glycol diformate, propylene glycol diacetate, glyceryl triacetate, hexose acetates, and the acetate, propionate and n-butyrate esters of sorbitol, mannitol and xylitol, and the like.

In the practice of the invention the more volatile component of the two, i.e. the more volatile out of the carboxylic acid component and the alcohol component, will often be the alcohol component. On the other hand, in the production of the di-n-butyryl ester of ethylene glycol from n-butyric acid and ethylene glycol, for example, n-butyric acid will be the more volatile component. Similarly, in the production of propylene glycol diformate from propylene glycol and formic acid, the more volatile component will be the carboxylic acid component, i.e. formic acid.

The esterification conditions used in the column reactor will normally include use of elevated temperatures up to about 160° C. for example a temperature in the range of from about 80° C. to about 140° C. preferably in the range of from about 100° C. to about 125° C. Such operating temperatures will be determined by such factors as the thermal stability of the esterification catalyst, the kinetics of the esterification reaction and the vapor temperature of the vaporous component fed to the base of the column reactor at the relevant inlet pressure. Typical operating pressures at the vapor inlet of the column reactor range from about 0.1 bar to about 25 bar. A liquid hourly space velocity through the column reactor in the range of from about 0.1 hr⁻¹ to about 10 hr⁻¹, typically from about 0.2 hr⁻¹ to about 2 hr⁻¹, may be used.

The alcohol component or the carboxylic acid component or a mixture thereof may be supplied to an upper part of the column reactor in liquid form, in solution in recycled ester product or in solution in an inert solvent or diluent thereof. In some cases it may be desired to prereact the alcohol component and the carboxylic acid component prior to introduction to the column reactor. Such prereaction may be used, for example, in a case in which reaction between the two components can be initiated in the absence of added catalyst. The reaction of an acid anhydride, such as maleic anhydride or phthalic anhydride, with an alcohol component, such as an alkanol (e.g. methanol, ethanol or n-butanol) is an example of such a reaction, the formation of the corresponding monoester occurring under moderate conditions, e.g. 60° C. and 5 bar, without the need of any added catalyst. This monoester product (i.e., the anhydride reacted to yield a monoester) still contains one more carboxylic acid functional group, so some formation of diester may occur. The resulting reaction mixture may contain a mixture of monoester, diester, water, and alkanol. Further alkanol can be added, if desired, to the mixture prior to introduction to the column reactor for conversion of the monoester to the diester.

In other cases, even when a monocarboxylic acid ester is the desired product, the alcohol component and the carboxylic acid component can be reacted to equilibrium in the presence of an acidic ion exchange resin containing —SO₃H and/or —COOH groups prior to introduction of the resulting equilibrium mixture to the column reactor.

In the process of the invention a vaporous mixture exits the column reactor as an overhead product. Provision may be made for scrubbing such vaporous mixture with the more volatile component (usually the alcohol component) in liquid form in order to wash traces of carboxylic acid ester product and of the other component (usually the carboxylic acid component) back into the column reactor. This overhead product from the column reactor can be condensed and treated in known manner to separate its constituents, the recovered water of esterification being rejected and the more volatile component (usually the alcohol component) being recycled for re-use in as dry a form as is practicable within the relevant economic constraints. The lower the water content of the vapor that is supplied to the lowermost one of said esterification trays, the further towards 100% conversion to ester the esterification equilibrium reaction can be driven and the lower the residual acidity of the ester containing product recovered from the bottom of the column reactor will be. However, a balance may often have to be struck between the cost of providing, for example, a substantially dry alkanol for vaporization into the column reactor, on the one hand, and the cost of providing and operating any additional downstream processing facilities that may be required to upgrade the ester product to the required quality if a less dry alkanol is used. This will vary from alkanol to alkanol and will depend upon the interaction between water and alkanol (e.g. azeotrope formation) and its effect upon alkanol/water separation. Preferably, when using an upflowing alkanol vapor in the column reactor, the water content of the alkanol vapor supplied to the reactor is less than about 5 mole %, and even more preferably is less than about 1 mole %. In one embodiment, the water content of the alkanol vapor is less than about 1500 ppm water. In a preferred embodiment, the water content of the alkanol vapor is less than about 0.27 mole %.

The column reactor has a plurality of esterification trays. Although two or three trays may suffice in some cases, it will typically be necessary to provide at least about 5 up to about 20 or more esterification trays in the column reactor. Typically each esterification tray is designed to provide a residence time for liquid on each tray of from about 1 minute up to about 120 minutes, preferably from about 5 minutes to about 60 minutes.

The solid esterification catalyst may be a granular ion exchange resin containing —SO₃H and/or —COOH groups. Macroreticular resins of this type are preferred. Examples of suitable resins are those sold under the trade marks AMBERLYST, DOWEX, DOW and PUROLITE such as AMBERLYST, AMBERLYST 66, DOW C351 and PUROLITE C150.

Different solid esterification catalysts may be used on different trays of the column reactor. Moreover different concentrations of solid esterification catalyst can be used on different trays.

The charge of solid particulate or granular esterification catalyst on each tray is typically sufficient to provide a catalyst:liquid ratio on that tray corresponding to a resin concentration of at least 0.2% w/v, for example a resin concentration in the range of from about 2% w/v to about 20% w/v, preferably 5% w/v to 10% w/v, calculated as dry resin. Sufficient catalyst should be used to enable equilibrium or near equilibrium conditions to be established on the tray within the selected residence time at the relevant operating conditions. On the other hand not so much catalyst should be used on each tray that it becomes difficult to maintain the catalyst in suspension in the liquid on the tray by the agitation produced by the upflowing vapor entering the tray from below. For a typical resin catalyst a resin concentration in the range of from about 2% v/v to about 20% v/v, preferably 5% v/v to 10% v/v may be used.

The particle size of the catalyst should be large enough to facilitate retention of the catalyst on each tray by means of a screen or similar device. However, as the larger the catalyst particle size is the more difficult it is to maintain in suspension and the lower the geometrical surface area per gram, it is expedient to use not too large a catalyst particle size. A suitable catalyst particle size is in the range of from about 0.1 mm to about 5 mm.

One or more wash trays may be provided above the esterification trays in order to prevent loss of product, solvent and/or reagents from the column reactor.

In the column reactor the vapor upcomer means associated with each esterification tray may comprise a sparger positioned so that, in operation, it will lie below the surface of the mixture of liquid and solid esterification catalyst on that tray and so that vapor bubbles emerging therefrom will agitate said mixture of liquid and solid particulate catalyst. The sparger may be a ring sparger. At least one baffle means may be mounted in the vicinity of the sparger to enhance the mixing action thereof. For small scale operation a sparger on the axis of the column reactor under a cylindrical baffle can be used.

In one embodiment the sparger is a ring sparger and inner and outer annular baffle means are positioned in the vicinity of the sparger and define an upflow zone in the region of upflowing vapor bubbles and adjacent downflow zones within and outside the upflow zone.

It is important to avoid stagnant zones where solid esterification catalyst can settle out because this can lead to excessive formation of by-products or to occurrence of hot spots. Although mechanical stirrers can be provided on each tray to maintain the catalyst particles suspended in liquid, this adds somewhat to the complexity of the reactor. It is possible, however, by suitable design of the sparger and tray to ensure that the upflowing vapor provides sufficient agitation in passage through the liquid on the tray to maintain the catalyst particles in suspension. To achieve this end it is convenient if at least a part of the floor of one or more (and preferably all) of the esterification trays slopes towards a zone where there is turbulence caused by the upflowing vapor such as is to be found under the sparger. The angle of slope is preferably selected so as to be equal to or greater than the angle of repose of the solid particulate esterification catalyst under the liquid in the esterification tray. The adoption of such a slope will tend to ensure that all of the catalyst is in dynamic contact with the liquid during operation and that no stagnant zones of catalyst are formed. Such stagnant zones are undesirable because they can enable undesirable side reactions or even thermal runaways to occur in certain instances.

In a preferred apparatus the vapor upcomer means of one or more (and preferably all) of the esterification trays is or are provided with a liquid suckback preventer means.

A screen means may be provided on at least one esterification tray to hinder loss of solid esterification catalyst from that esterification tray via its associated downcomer means. In this way downward flow of the solid catalyst from one esterification tray to the next lower one can be substantially prevented.

Means may be provided for withdrawing resin from, or adding resin to, one or more of the trays during operation of the column reactor. For example, a conduit having a down turned open end can extend into the interior of a respective tray with its open lower end positioned at a low point within the tray. By this means a slurry of catalyst and liquid can be withdrawn in controlled manner from the tray intermittently or continuously, as desired, or further catalyst can be introduced in slurry form to the trays, as desired. Catalyst withdrawn from a given tray can be re-introduced into the column reactor, either into the same tray or to a lower or higher one, possibly after being given a regeneration treatment.

In order that the invention may be clearly understood and readily carried into effect three preferred forms of plant for continuous production of esters, and corresponding preferred processes for use in connection therewith, will now be described, by way of example only, with reference to the accompanying drawings. It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

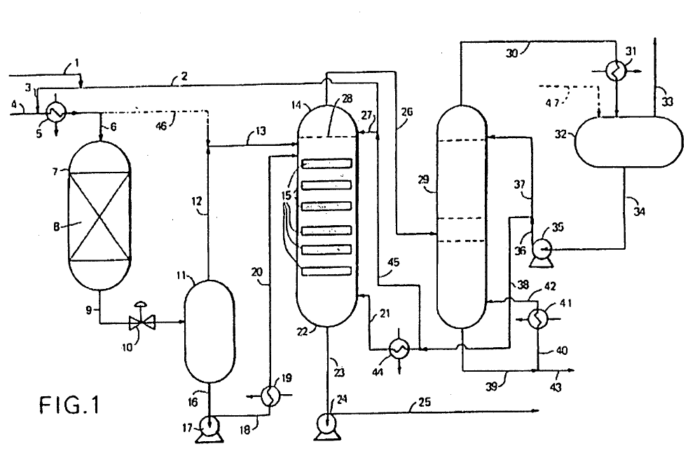

Referring to FIG. 1 of the drawings, methanol is supplied to the plant in line 1 and is admixed with recycled methanol in line 2 to form a methanol feed to the plant in line 3. A fatty acid mixture, for example a mixture of fatty acids obtained by hydrolysis of a naturally occurring triglyceride, e.g. coconut oil, followed by “topping and tailing”, is fed in line 4 and mixed with the methanol feed from line 3 before flowing to a heat exchanger 5, in which its temperature is raised to 110° C. The heated acid/methanol mixture flows on in line 6 into primary esterification reactor 7, which contains a charge 8 of an ion exchange resin containing sulphonic acid and/or carboxylic acid groups, such as AMBERLYST 13. The pressure in reactor 7 is 5 bar.

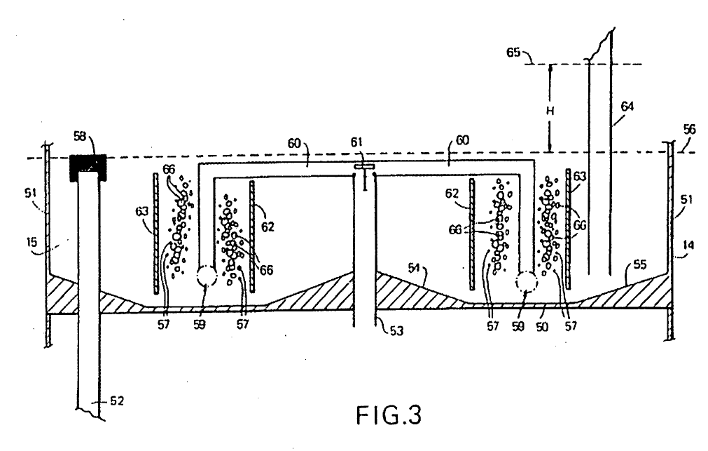

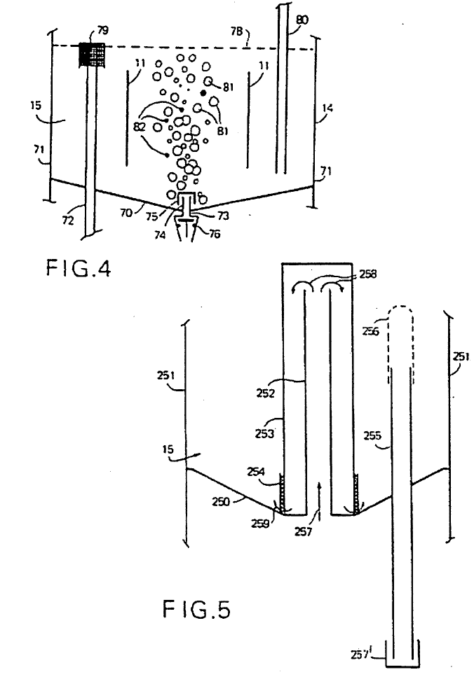

In reactor 7 part of the acid mixture is esterified by reaction with methanol to yield a corresponding mixture of methyl fatty acid esters. There exits from reactor 7 in line 9 a mixture of methyl esters, unreacted fatty acid, water produced by esterification and unreacted methanol. This mixture passes through a pressure let down valve 10 into a vapor/liquid separator 11. A vapor phase comprising methanol and water is fed at 1.3 bar by way of lines 12 and 13 to an upper part of an esterification reactor 14. Reactor 14 is provided with a number of esterification trays 15; two possible forms of esterification tray 15 are illustrated in FIGS. 3 and 4 and will be described in greater detail below. In the plant of FIG. 1 there are six trays 15; however, a greater or lesser number of such trays (e.g. any number from 3 to 5 or 7 to 20) may be provided, depending upon the nature of the fatty acid and the reaction conditions selected.

The liquid phase from vapor/liquid separator 11 is fed by way of line 16, pump 17 and line 18 to heat exchanger 19, in which it is heated by steam to a temperature of up to 150° C., e.g. 120° C., and then by means of line 20 to reactor 14 at a point below the entry point of line 13.

In reactor 14 the downflowing unreacted fatty acids in the mixture in line 20 pass downwardly from each esterification tray 15 to the next lower tray 15 against an upflowing current of vapor comprising methanol and water of esterification, i.e. water produced as a result of the esterification reaction. Dry methanol vapor is supplied to reactor 14 in line 21. Each esterification tray 15 holds a charge of an acidic ion exchange resin, such as a resin containing sulphonic acid groups. AMBERLYST 13 is a suitable resin. In passage down column 14 any unreacted free acid encounters progressively drier methanol vapor on each tray 15. By designing each tray 15 to provide an appropriate liquid hold up, it is possible to regulate the residence time on each tray 15. By selecting a suitable number of trays 15 it is further possible to design reactor 14 so that essentially no free fatty acid remains in the liquid passing downwards from the bottom tray 15 into the sump 22 of reactor 14. Methyl ester product (i.e. a mixture of methanol and methyl esters derived from the mixed fatty acids supplied in line 4) is removed from sump 22 in line 23 and pumped onward by pump 24 via line 25 for further treatment or to a product refining facility or to storage.

A mixture of methanol vapor and the water released in the esterification reaction is recovered overhead from reactor 14 in line 26. Liquid methanol is supplied in line 27 to an upper part of reactor 14 above the point of connection of line 13 to provide liquid methanol on wash tray 28.

The vapor in line 26 is fed to a methanol/water separation column 29 which is operated at 1.3 bar and at a head temperature of 70° C. Dry methanol vapor is recovered overhead in line 30 and is condensed in condenser 31. The resulting condensate is collected in drum 32 which is vented as indicated at 33. Dimethyl ether produced as byproduct is vented in line 33. Methanol which would otherwise be lost along with the dimethyl ether can be recovered by providing a chilled condenser (not shown) in line 31. Part of the condensed methanol is recycled to column 29 from drum 32 as a reflux stream in line 34 by means of pump 35 and lines 36 and 37. The remainder is pumped back for re-use in line 38.

The sump product from column 29 consists essentially of water. This is withdrawn in line 39. Part is recycled to column 29 by way of line 40, steam heated reboiler 41 and line 42; the remainder is passed on in line 43 for effluent treatment.

Some of the dry methanol in line 38 is passed through vaporizer 44 to provide the stream of dry methanol vapor in line 21. The rest flows on in line 45 to provide the recycle streams in lines 2 and 27.

In a modification of the plant of FIG. 1 reactor 7 and vapor/liquid separator 11 are omitted and the mixture of fatty acids and methanol is fed by way of line 46 to line 13.

In a further modification of the plant of FIG. 1 lines 1 to 3 and items 6 to 12 and 16 to 20 are omitted. Thus liquid fatty acid or fatty acid mixture is the sole liquid feed to reactor 14 and is supplied by way of lines 4, 46 and 13. Make up methanol for the plant can be supplied through line 47 to reflux drum 32.

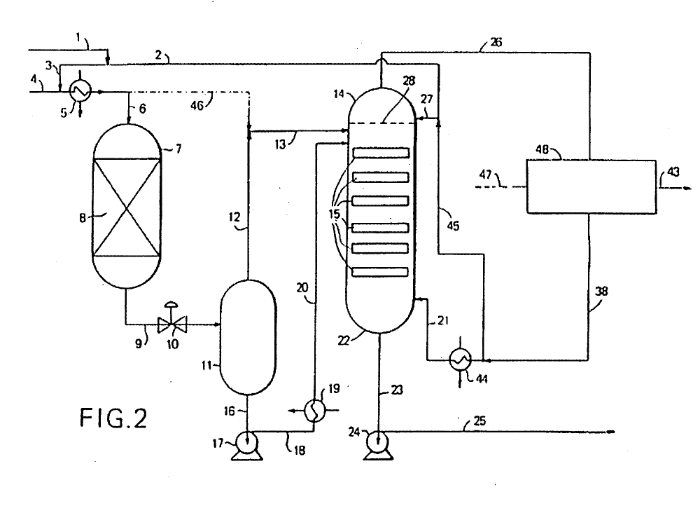

FIG. 2 illustrates an alternative form of plant suitable for production of mono-, di- and polycarboxylic acid esters which have a significantly higher boiling point than that of the alcohol used and of any water/alcohol azeotrope that may be formed.

In the plant of FIG. 2 the same reference numerals are used to indicate like parts to those present in the plant of FIG. 1, except that line 1 is used for supply, not of methanol, but of a higher alcohol such as ethanol or a higher alkanol containing up to 10 carbon atoms. The product in line 25 is thus an ethyl or higher ester of a mono-, di- or polycarboxylic acid. Reference numeral 48 indicates any suitable alkanol/water separation plant.

Similar modifications to the plant of FIG. 2 can be made to those described above, i.e. omission of items 1 to 3, 6 to 12 and 16 to 20 to permit supply of liquid fatty acid or fatty acid mixture as the sole liquid feed to reactor 14.

FIG. 3 illustrates one form of construction of a tray 15 of reactor 14 of the plants of FIGS. 1 and 2. A horizontal diaphragm or partition 50 extends within wall 51 of reactor 14 and closes off the cross section of reactor 14 completely except for a downcomer 52 for liquid and a vapor upcomer 53. Partition 50 has an axial frusto-conical part 54 surrounding vapor upcomer 53 and an annular sloping portion 55 adjacent wall 51. Tray 15 can thus retain a volume of liquid whose surface is indicated at 56 and whose volume is determined by the height of the overflow level of downcomer 52 above the partition 50. Each tray 15 also supports a charge of an acidic ion exchange resin containing —SO₃H groups, such as AMBERLYST 13, whose particles are indicated diagrammatically at 57. Such ion exchange particles are kept in suspension in the liquid on tray 15 as a result of agitation caused by the upcoming vapor as will be described below. To prevent escape of ion exchange particles 57 with the liquid overflowing down downcomer 52 the top of downcomer 52 is provided with a screen 58. The slope of conical part 54 and of sloping portion 55 is equal to or greater than the angle of repose of the AMBERLYST 13 or other solid particulate esterification catalyst under the liquid on esterification tray 15.

Vapor upcomer 53 conducts upcoming vapor to a circular sparger 59, which surrounds frusto-conical part 54, by way of spider tubes 60. Suckback of liquid down upcomer 53 is prevented by means of an anti-suckback valve 61.

Annular draught shrouds or baffles 62 and 63 are positioned within the body of liquid on tray 15, one inside and one outside circular sparger 59 to promote agitation of the liquid/resin suspension by the upcoming vapor. The vertical extent of shrouds 62 and 63 is not critical but should generally be between one third and three quarters of the vertical height between diaphragm 50 and liquid surface 56. It is preferred that shrouds 62 and 63 should be placed in a symmetrical or near symmetrical vertical position. In the annular zone between shrouds 62 and 63 the liquid flow is generally upward whilst inside shroud 62 and outside shroud 63 the general direction of liquid flow is downward. Preferably the area of the annular zone between shrouds 62 and 63 approximately equals the sum of the areas inside shroud 62 and outside shroud 63.

Reference numeral 64 indicates a downcomer from the next tray above the one illustrated in FIG. 3. The liquid level in downcomer 64 is indicated at 65, the height H of this liquid level above liquid level 56 on tray 15 being fixed by the liquid level on the tray which feeds downcomer 64 (i.e. the tray above the illustrated tray 15) plus the pressure drop through the sparger 59 on that tray (i.e. the one above the illustrated tray 15) and the frictional pressure drop.

In operation of reactor 14 a mono-, di- or poly-carboxylic acid or mixture of acids is typically passed downwards in liquid form in countercurrent to an upflowing vaporous stream of alcohol. Each tray 15 acts as an esterification zone containing a respective charge of esterification catalyst which catalyses the esterification reaction and the release of water of esterification. Under the countercurrent conditions prevailing in the reactor 14 such water of esterification is vaporized and carried upwards through reactor 14 with the upflowing alcohol vapor. The liquid passes downwards from one tray 15 to the next downward tray 15 and the free acid concentration in the liquid on each tray 15 is lower than the corresponding acid concentration in the liquid on the next higher tray 15. In addition the liquid encounters drier and drier alcohol vapor on each tray 15 as it passes down through reactor 14. In this way the equilibrium of the esterification reaction is pushed further towards ester formation, the reverse hydrolysis reaction being effectively suppressed because the water concentration in the liquid on the trays 15 decreases from tray to tray in the downward direction.

By selecting a suitable number of trays 15 in column 14 and designing each tray 15 to provide a sufficient liquid hold up to provide the requisite residence time on each tray it is possible to design reactor 14 so that the product in line 25 contains less than about 1 mole % of carboxylic acid, together with fatty acid esters and alcohol as its principal components. By providing an adequate upflow rate for alcohol vapor the agitation caused by the vapor bubbles 66 emerging from circular sparger 59, coupled with the liquid circulation induced by the presence of draught shrouds 62 and 63, can suffice to maintain the acidic ion exchange resin particles sufficiently in suspension for esterification to proceed successfully. The surfaces of sections 54 and 55 slope towards the zone under the sparger 59 and ensure that there are no stagnant zones where significant quantities of resin can settle out of suspension. It will be appreciated that, although FIG. 3 only shows resin particles 57 in suspension in the zone between draught shrouds 62 and 63, they would in practice be present in suspension in the liquid phase outside this zone. If necessary, the volume of the upflowing vapor can be boosted by inert gas or by other vaporizable inert material, conveniently an inert material that is a byproduct of the process. For example, it is often found that an ether is found amongst the byproducts, as acidic catalysts can promote formation of an ether from the alcohol used. Thus, dimethyl ether is a potential byproduct if methanol is used as the alcohol, whilst diethyl ether can be formed in reactor 14 if ethanol is the alcohol used; either material can be used, if necessary, to boost vapor upflow to provide additional agitation on trays 15 or to provide additional vapor to carry away water of esterification.

In FIG. 4 there is illustrated an alternative design of esterification tray 15 suitable for use in a relatively small scale reactor 14. In this case a frusto-conical partition or diaphragm 70 extends within wall 71 of reactor 14 and closes off the cross section of reactor 14 completely except for a downcomer 72 for liquid and a vapor upcomer 73. The slope of frusto-conical diaphragm 70 is equal to or greater than the angle of repose of the solid particulate catalyst under the liquid present on tray 15. The vapor upcomer 73 includes an axial sparger 74 provided with a bubble cap 75 and is fitted with an anti-suckback valve 76. Optionally bubble cap 75 can be surrounded by a mesh screen (not shown) to prevent ingress of catalyst particles interfering with the operation of valve 76. A cylindrical baffle 77 surrounds sparger 74 symmetrically and is positioned beneath the liquid level 78, the height of which is determined by the height of the upper end of downcomer 72. A screen 79 is fitted to the top of downcomer 72 to retain solid esterification catalyst, e.g. AMBERLYST 13, on tray 15. Reference numeral 80 indicates the downcomer from the next higher esterification tray 15 (not illustrated). In a similar manner to that described in relation to FIG. 3 the bubbles 81 of vapor agitate the liquid on tray 15 and maintain particles 82 of catalyst in suspension. Baffle 77 defines an upflow zone within baffle 77 and a downflow zone outside baffle 77. Preferably the areas of the two zones are substantially equal. This design ensures that, so far as is possible, no stagnant zones where catalyst particles can sediment are formed.

If desired the feed line 20 or 13 in the plants of FIGS. 1 and 2 can be arranged to discharge onto a tray, similar to tray 15 of FIG. 3 or FIG. 4, which does not hold a charge of ion exchange resin. One or more alkanol wash trays may be provided above the connection of feed line 20 or 13 so that the vapors are scrubbed with a minor amount of liquid alkanol before exiting reactor 14 in line 26 so as to limit the amount of acid or ester to traces therein.

FIG. 5 illustrates a further design of esterification tray 15 suitable for use in a laboratory scale reactor 14 or in a commercial scale reactor 14. This comprises a generally frusto-conical partition or diaphragm 250 which extends within wall 251 of reactor 14. The slope of the upper surface of diaphragm 250 is greater than the angle of repose of the solid particulate catalyst. A vapor upcomer 252 is fitted with a cap 253 with a dependent skirt of mesh 254. Downcomer 255 is fitted with a mesh cap 256 and with a seal bucket 257. The upper end of downcomer 255 is positioned so as to provide a suitable retention volume for liquid on tray 15 whilst mesh skirt 254 and mesh cap 256 retain the charge of resin particles on diaphragm 250. Methanol vapor flows up upcomer 252 as indicated by arrow 257, through the space between upcomer 252 and cap 253 as indicated by arrows 258, and through skirt 254 as indicated by arrows 259, and carries with it water vapor resulting from water of esterification formed in a lower tray or trays.

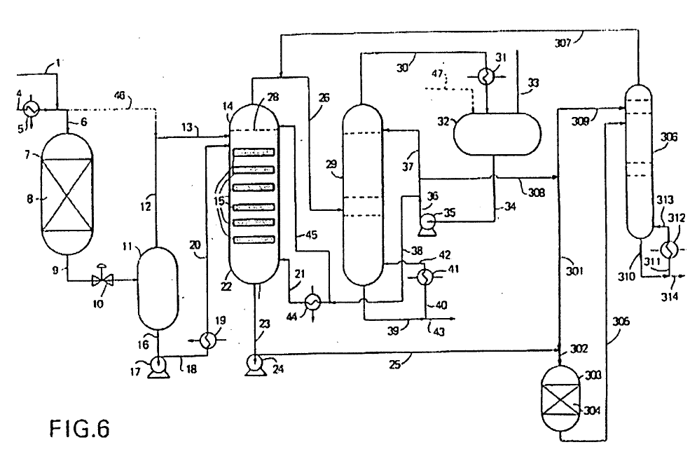

The plant of FIG. 6 is generally similar to that of FIG. 1 and like reference numerals have been used in both Figures to indicate like parts. The feed acid in line 4 is typically an unsaturated fatty acid, such as oleic acid.

In the plant of FIG. 6 line 2 is omitted so that there is no recycle of methanol for admixture with the feed methanol in line 1. Hence all of the methanol in line 45 is supplied to wash tray 28.

As the number of theoretical stages in column 14 does not necessarily correspond to the number of trays 15 fitted in column 14, and the number of such theoretical stages may vary, for a particular column, for different feed acids supplied in line 4, the acid content of the methyl ester product in line 23 may vary if the nature of the feed acid in line 4 is changed.

As already mentioned a by-product of ester formation in the column is often a dialkyl ether. The yield of such dialkyl ether by-product is found to be dependent upon the temperature of operation of the reactor 14. Hence by minimizing the temperature of operation of column reactor 14 the yield of by-product ether can be minimized. However, a corollary of this is that a lower conversion of acid to ester is obtained at lower operating temperatures. In this case it is possible to optimize the conversion to ester by admixing the ester-containing product, which contains perhaps about 97 mole % to about 99 mole % of ester with the balance being acidic materials, with further alkanol (e.g. methanol) and passing the resulting mixture containing, for example, a 2:1 to 4:1, e.g. 3:1, alkanol:ester molar mixture through a polishing reactor having a fixed bed of a solid esterification catalyst, such as AMBELYST 13, which can be operated at a lower temperature than the column reactor. In this way extremely high overall conversion to ester can be achieved. Such a modified form of plant is illustrated in FIG. 6.

In the plant of FIG. 6 there are six esterification trays 15 and the methyl ester product in line 23 still contains a minor amount of oleic acid. Typically the methyl oleate:oleic acid molar ratio is in the region of 97:3. This mixture is admixed with further methanol supplied from line 301 to form a mixture having a molar ratio of methanol:methyl oleate:oleic acid of 3:0.97:0.03. This mixture is supplied in line 302 at a temperature of 60° C. and at a liquid hourly space velocity of 1 hr⁻¹ to a further esterification reactor 303 containing a fixed bed 304 of an acidic ion exchange resin, such as AMBERLYST 13. The resulting mixture flows on in line 305 to a further distillation column 306. Methanol vapor passes overhead via line 307 to column 29 via line 26. Liquid methanol to form a reflux stream and the stream in line 301 is pumped from condensate drum 32 by pump 35 through line 308. The reflux stream flows on in line 309 to column 306. The bottom product from column 306 in line 310 comprises essentially pure methyl oleate (of purity at least 99.5 mole %). Part is recycled to column 306 by way of line 311 via column reboiler 312 and line 313, whilst the remainder is passed to storage or onward for further treatment in line 314.

The plants of FIGS. 1 and 2 and the trays 15 illustrated in FIGS. 3 and 4 have been described in the context of acid containing liquid phase downflow and upcoming vaporous alcohol flow. If the acid used is more volatile than the alcohol component, then the directions in which the acid and alcohol components flow can be reversed, so that the alcohol is in liquid phase and flows down from one tray 15 to the next downward tray 15 through reactor 14 whilst acid vapor passes upwardly in countercurrent thereto.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment is in accordance with conventional chemical engineering practice. Modifications and variations of the present invention relating to the selection of fatty acid feedstocks, alcohols and catalysts are intended to come within the scope of the invention. All references cited herein are hereby incorporated by reference.

1. A method for obtaining U.S. Federal tax credits under Title 26 Sections 40A and/or 6426 for ester based fuels, and/or a method for obtaining Renewable Identification Numbers under the EPA Clean Air Act as amended by the Energy Independence and Security Act of 2007, comprising:
(A) producing carboxylic acid esters with an apparatus comprising:
i) a column reactor provided with a plurality of esterification trays mounted one above another, each adapted to hold a predetermined liquid volume and a charge of particles of a solid esterification catalyst thereon,
ii) liquid downcomer means associated with each esterification tray adapted to allow liquid phase to pass down the column reactor from that esterification tray but to retain the particles of solid esterification catalyst thereon,
iii) vapor upcomer means associated with each esterification tray adapted to allow vapor to enter that esterification tray from below and to agitate and maintain the suspension of the mixture of liquid and solid esterification catalyst on that esterification tray,
wherein each esterification tray has a floor that slopes towards a zone of turbulence under said vapor upcomer means to prevent formation of stagnant zones of particles of catalyst thereon,
iv) means for supplying the less volatile component of the carboxylic acid component and of the alcohol component in liquid phase to an upper part of the column reactor above the uppermost esterification tray,
v) means for supplying the more volatile component of the carboxylic acid component and of the alcohol component in vapor form to a lower part of the column reactor below the lowermost esterification tray,
vi) means for recovering carboxylic acid ester from a lower part of the column reactor below the lowermost esterification tray, and
vii) means for recovering from an upper part of the column reactor above the uppermost esterification tray a vaporous stream comprising said more volatile component and water of esterification;
and
(B) having a tax payer use product of step (A) for a claim for U.S. Federal tax credits under Title 26 Sections 40A and/or 6426, and/or for U.S. Federal Renewable Identification Numbers under Environmental Protection Agency Clean Air Act as amended by the Energy Independence and Security Act of 2007.

2. A method according to claim 1, wherein said vapor upcomer means comprises a sparger positioned so that, in operation, it will lie below the surface of the mixture of liquid and solid esterification catalyst and so that vapor bubbles emerging therefrom will agitate said mixture of liquid and catalyst.

3. A method according to claim 2, wherein the sparger is a ring sparger.

4. A method according to claim 2, wherein at least one baffle means is mounted in the vicinity of the sparger to enhance the mixing action thereof.

5. A method according to claim 4, wherein inner and outer annular baffle means are positioned in the vicinity of the sparger and define an upflow zone in the region of upflowing vapor bubbles and adjacent downflow zones within and outside the upflow zone.

6. A method according to claim 2, wherein the vapor upcomer means of at least one esterification tray is provided with a suckback preventer means.

7. A method according to claim 2, wherein a screen means is provided on at least one esterification tray to hinder loss of solid esterification catalyst from that esterification tray via its associated downcomer means.

8. A method according to claim 1, further comprising a reactor containing a fixed bed of a solid esterification catalyst connected downstream from the column reactor and means for admixing an additional alcohol component with the carboxylic acid ester component recovered from a lower part of the column reactor prior to entry to the further reactor.
